(19) United States
(12) Patent Application Publication
(10) Pub. No.: US 2007/0263986 A1
(43) Pub. Date: Nov. 15, 2007

(54) Video/sound player, video/sound reproducing method, computer readable recording medium, and computer data signal embodied in carrier wave

(75) Inventors: Takashi Matsubara, Kanagawa (JP); Hideo Ito, Kanagawa (JP)

Correspondence Address: COHEN, PONTANI, LIEBERMAN & PAVANE, 551 FIFTH AVENUE, SUITE 1210, NEW YORK, NY, 10176, US

(73) Assignee: Casio Hitachi Mobile Communications Co., Ltd., Tokyo (JP)

(21) Appl. No.: 11/800,031

(22) Filed: May 3, 2007

(30) Foreign Application Priority Data
May 12, 2006 (JP) 2006-134442

(51) Int. Cl. H04N 7/00

(52) U.S. Cl. 386/96

(57) ABSTRACT

A video/sound player monitors if the video/sound player is folded by using a sensor unit. When the video/sound player is folded while reproducing a digital content including a video image and a sound, the video/sound player stops reproducing the digital content including the video image and sound, and reproduces digital content data useful with a sound alone predesignated by a user using an input unit.

### BACKGROUND OF THE INVENTION

1. Field of the Invention

The present invention relates to a video/sound player which plays back a content including a video image and a sound. More particularly, the invention relates to a video/sound player capable of switching between playback of a video image and a sound and playback of only a sound.

2. Description of the Related Art

There is a video/sound player a user can carry around when going out or so. There may be a case where while such a video/sound player is playing back (or reproducing) a content including a video image and a sound, a user stops viewing, or cannot view, the video image in reproduction depending on crowded conditions. There is a video/sound player which allows a user to listen only to the sound of a content including a video image and a sound in such a case by keeping reproducing only the sound accompanying the video image.

Unexamined Japanese Patent Application KOKAI Publication No. 2005-167687, for example, discloses a foldable portable terminal having a capability of receiving digital television broadcasting. When folded during reception of digital data of the digital television broadcasting, the portable terminal interrupts display of a video image, and causes a sound output device to reproduce only the sound of the digital data being received when the sound output device is connected to the portable terminal. When the sound cannot be reproduced either, the portable terminal stores the digital data being received in a memory, and displays the digital data, stored in the memory during interruption, when the display of the video image becomes possible after the interruption. Apparently, the portable terminal disclosed in Unexamined Japanese Patent Application KOKAI Publication No. 2005-167687 reproduces only a sound accompanying digital television broadcasting while display of a video image is interrupted.

Television broadcasting is a content which is mainly intended to permit people to enjoy both a video image and a sound. Even if the user of the portable terminal merely listens to a sound without viewing the video image of the television broadcasting, therefore, the user may not enjoy the television broadcasting. By way of contrast, radio broadcasting or the like is an example of a content intended to permit people to enjoy a sound alone.

Therefore, there may be a case where the user may want to listen to a content containing only a sound, such as radio broadcasting, not a sound of television broadcasting, when the user stops viewing the video image or becomes unable to view the video image. In such a case, to switch a reproduction target of the video/sound player, the user needs to select a content to be reproduced by repeating a menu operation involving key inputs or so several times.

This operation is troublesome when the user carries around and uses the video/sound player when going out or so. Even when a circumstance where a video image is visible and a circumstance where a video image is not visible are frequently changed from one to the other, the user needs to perform a menu operation to change a content to be reproduced each time. This is troublesome to the user. Therefore, the conventional video/sound player needs to deal with an issue of how to smoothly reproduce a content desired by a user according to the user's using condition.

### SUMMARY OF THE INVENTION

Accordingly, it is an object of the present invention to provide a video/sound player capable of smoothly changing a content to be reproduced according to the using condition of a user.

To achieve the object, a video/sound player according to one aspect of the present invention includes:

a content reproduction unit that reproduces a content including at least one of a video image and a sound and outputs at least one of a video signal and a sound signal;

a discrimination unit that discriminates whether or not a user is viewing a video image of a content including a video image reproduced by the content reproduction unit; and

a content reproduction control unit that, while the content reproduction unit is reproducing a content including a video image, causes the content reproduction unit to reproduce predetermined sound data in place of the content which is being reproduced by the content reproduction unit, when the discrimination unit discriminates that the user is not viewing the video image of the content.

A video/sound reproducing method according to the second aspect of the invention includes:

a reproduction step of reproducing a first content including a video image;

a display step of displaying the video image of the first content reproduced in the reproduction step on a display unit;

a discrimination step of discriminating whether or not a state of the display unit is a visible state where a user can view the video image displayed in the display step; and

a reproduction switching step of switching the reproduction of the first content to reproduction of a second content including sound and different from the first content, when it is discriminated in the discrimination step that the display unit is not in the visible state.

A computer readable recording medium according to the third aspect of the invention records a program for allowing a computer to execute:

a reproduction step of reproducing a first content including a video image;

a display step of displaying the video image of the first content reproduced in the reproduction step on a display unit;

a discrimination step of discriminating whether or not a state of the display unit is a visible state where a user can view the video image displayed in the display step; and

a reproduction switching step of switching the reproduction of the first content to reproduction of a second content including sound and different from the first content, when it is discriminated in the discrimination step that the display unit is not in the visible state.

According to the fourth aspect of the invention, there is provided a computer data signal embodied in a carrier wave representing a program for allowing a computer to execute:

a reproduction step of reproducing a first content including a video image;

a display step of displaying the video image of the first content reproduced in the reproduction step on a display unit;

a discrimination step of discriminating whether or not a state of the display unit is a visible state where a user can view the video image displayed in the display step; and

a reproduction switching step of switching the reproduction of the first content to reproduction of a second content including sound and different from the first content, when it is discriminated in the discrimination step that the display unit is not in the visible state.

According to the present invention, it is possible to smoothly change a content to be reproduced according to how a video/sound player is used by a user.

### BRIEF DESCRIPTION OF THE DRAWINGS

These objects and other objects and advantages of the present invention will become more apparent upon reading of the following detailed description and the accompanying drawings in which:

FIG. 1 is a block diagram showing the configuration of a video/sound player according to a first embodiment of the present invention;

FIGS. 2A and 2B are diagrams exemplarily showing the appearance of the video/sound player according to the first embodiment;

FIG. 3 is a diagram showing an example of a menu screen to be displayed on the display unit;

FIG. 4 is a flowchart illustrating an example of a switching process according to the first embodiment;

FIG. 5 is a diagram exemplarily showing the appearance of a video/sound player according to a second embodiment of the invention;

FIG. 6 is a flowchart illustrating an example of a switching process according to the second embodiment; and

FIGS. 7 and 8 are flowcharts illustrating an example of a switching process according to a third embodiment of the invention;

### DETAILED DESCRIPTION OF THE PREFERRED EMBODIMENTS

Preferred embodiments of the present invention will now be described with reference to the accompanying drawings.

The following description of the preferred embodiments will be given of a case where the invention is adapted to a portable information terminal having various functions, such as a video/sound reproducing function and a telephone function.

### First Embodiment

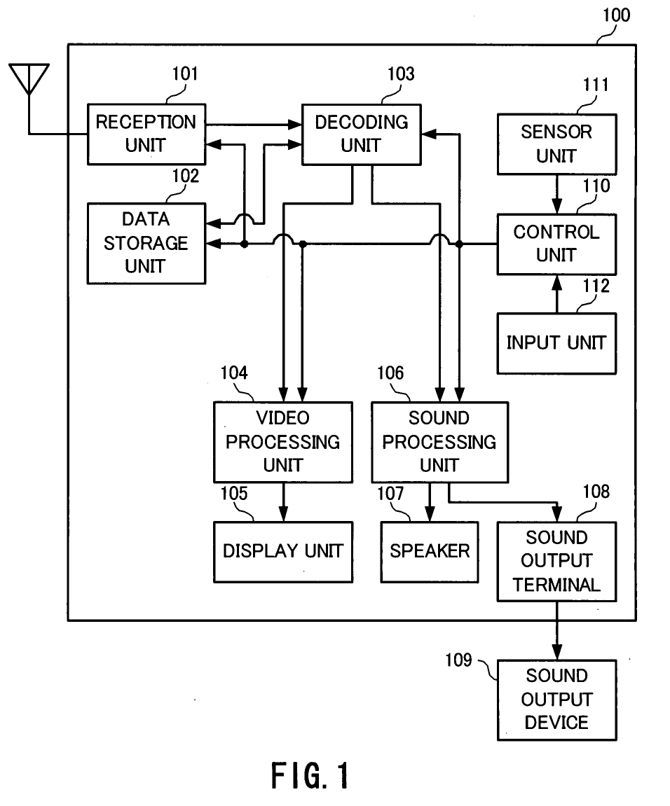

FIG. 1 is a block diagram showing the configuration of a video/sound player according to the first embodiment of the invention.

The video/sound player 100 according to the embodiment is a compact and foldable portable information terminal which can be carried around by a user. As shown in FIG. 1, the video/sound player 100 has a reception unit 101, a data storage unit 102, a decoding unit 103, a video processing unit 104, a display unit 105, a sound processing unit 106, a speaker 107, a sound output terminal 108, a control unit 110, a sensor unit 111, and an input unit 112.

The reception unit 101 is a circuit to which a radio wave signal received at an antenna is input. The reception unit 101 demodulates a radio wave signal acquired from the antenna to restore data which can be digitally processed by the decoding unit 103. For example, the reception unit 101 receives digital broadcasting (digital broadcasting content), such as “digital television broadcasting, “digital radio broadcasting”, “FM sound multiplex broadcasting”, and “streaming sound broadcasting”. Specifically, when the antenna receives a desired broadcast wave of “digital television broadcasting, “digital radio broadcasting”, “FM sound multiplex broadcasting” or so, the reception unit 101 acquires digital content data from the broadcast wave. When the antenna receives a desired communication wave of “streaming sound broadcasting” from a communication network such as the Internet wirelessly, the reception unit 101 acquires stream-distributed digital content data from the communication wave.

The data storage unit 102 is constituted by a flash memory or the like. The data storage unit 102 stores digital content data including video data, sound data and the like.

Digital content data is input to the decoding unit 103 from the reception unit 101. The decoding unit 103 separates digital video data and digital sound data from the digital content data. Further, the decoding unit 103 decodes the digital video data and digital sound data to convert both types of data to have data formats that can be processed respectively by the video processing unit 104 and the sound processing unit 106. The decoding unit 103 outputs the decoded digital video data to the video processing unit 104, and outputs the decoded digital sound data to the sound processing unit 106.

When the digital content data received by the reception unit 101 is stored in the data storage unit 102, the digital content data is output to the data storage unit 102 via the decoding unit 103. In case of reproducing the digital content data stored in the data storage unit 102, the digital content data is output to the decoding unit 103 from the data storage unit 102.

The video processing unit 104 converts digital video data supplied from the decoding unit 103 to video data of a format which can be processed by the display unit 105, and outputs the converted video data to the display unit 105.

The display unit 105 includes, for example, a liquid crystal display panel and a driver therefor. The display unit 105 displays a video image based on the video data supplied from the video processing unit 104.

The sound processing unit 106 converts digital sound data supplied from the decoding unit 103 to analog sound data, and outputs the converted analog sound data to the speaker 107 or the sound output terminal 108.

The speaker 107 converts analog sound data supplied from the sound processing unit 106 to a sound, and outputs the sound.

The sound output terminal 108 has a general-purpose sound output connection terminal. A sound output device 109 like a headphone (including an earphone) is connected to the sound output terminal 108. The sound output terminal 108 transfers analog sound data to the connected sound output device 109.

The sound output device 109 converts analog sound data supplied via the sound output terminal 108 from the sound processing unit 106 to a sound, and outputs the sound.

The control unit 110, which includes a microprocessor or so incorporating, for example, a memory, performs the general control of the video/sound player 100. Specifically, the control unit 110 includes a CPU (Central Processing Unit), ROM (Read Only Memory) and RAM (Random Access Memory), and performs arithmetic operations and a control process. The arithmetic operations and control process are performed as the CPU executes a program stored in the ROM while temporarily storing various kinds of data using the RAM as a work area. As the control unit 110 controls the individual components of the video/sound player 100 according to the program stored in the ROM, a reproduction process on digital content data, a switching process on digital content data to be reproduced, and so forth are executed.

The sensor unit 111 includes a magnet sensor or the like. The sensor unit 111 discriminates whether or not the video/sound player 100 is folded, and notifies the control unit 110 of information indicating the discrimination result. For example, the sensor unit 111 detects the folded state of the video/sound player 100 based on the difference in the sensed magnetic strength between a state where the video/sound player 100 is folded and a state where the video/sound player 100 is not folded, and outputs a detection signal to the control unit 110.

The input unit 112 has, for example, a plurality of input keys. When the user operates the input keys, the input unit 112 notifies the control unit 110 of information corresponding to the key operation.

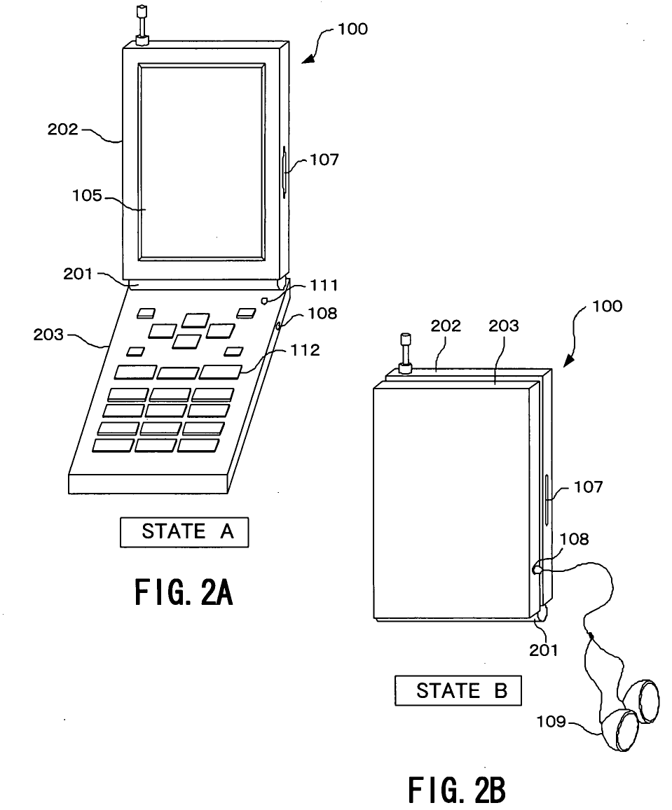

FIGS. 2A and 2B are diagrams exemplarily showing the appearance of the video/sound player 100. To avoid a redundant specific description, like or same reference numerals are given to those components in FIGS. 2A and 2B which have the same functions as the corresponding components in FIG. 1.

The video/sound player 100 has a hinge portion 201, a first casing 202 and a second casing 203, as shown in FIGS. 2A and 2B.

The hinge portion 201 connects the first casing 202 and the second casing 203 together. The hinge portion 201 has a mechanism which rotates the first casing 202 and the second casing 203, connected together by the hinge portion 201, about a rotary shaft. As the user rotates the first casing 202 with respect to the second casing 203 with the hinge portion 201 as the rotary shaft, for example, the video/sound player 100 can be folded so that the first casing 202 and the second casing 203 overlie each other.

FIG. 2A shows a state where the video/sound player 100 is not folded (state A), i.e., a state where the first casing 202 and the second casing 203 are open with the hinge portion 201 being the center. FIG. 2B shows a state where the video/sound player 100 is folded (state B), i.e., a state where the first casing 202 and the second casing 203 are closed with the hinge portion 201 being the center.

The video/sound player 100 is so configured as to be switchable between the open state A where the video/sound player 100 is open with the hinge portion 201 being the center as shown in FIG. 2A and the closed state B as shown in FIG. 2B.

The display unit 105, the speaker 107, etc. are disposed in the first casing 202. The sound output terminal 108, the sensor unit 111, the input unit 112, etc. are disposed in the second casing 203.

Switching between the state A and the state B is carried out by changing the facing direction of that side of the first casing 202 where the display unit 105 is disposed with respect to the second casing 203.

In the state A, therefore, the display unit 105 is exposed so that the user can view a video image displayed on the display unit 105. That is, the state A indicates the state where the user can view a video image.

In the state B, on the other hand, the display unit 105 is shielded by the second casing 203 so that the user cannot view a video image displayed on the display unit 105. That is, the state B indicates the state where the user cannot view a video image.

When the user folds the video/sound player 100, the sensor unit 111 senses that the side of the first casing 202 where the display unit 105 is disposed faces the side of the second casing 203 where the input unit 112 is disposed. For example, the sensor unit 111 including a magnet sensor and disposed in the second casing 203 detects the approach of the side of the first casing 202 where the display unit 105 is disposed by the strength of the magnetism sensed, and outputs a detection signal to the control unit 110. According to the detection signal, the control unit 110 discriminates if the video/sound player 100 is folded.

The operation of the thus configured video/sound player 100 will be described next.

When the user stops viewing a video image while viewing a content including the video image and a sound, or becomes unable to view the video image, the video/sound player 100 switches the reproduction target from the content the user has been viewing so far to a content which does not include a video image. Specifically, when the user stops viewing (or becomes unable to view) a video image, the video/sound player 100 reproduces a content useful with a sound alone (substitute content) in place of a content useful with both a video image and a sound. In the embodiment, it is discriminated that the user stops viewing a video image when the video/sound player 100 is folded.

For the video/sound player 100 to change a content to be reproduced according to the use condition, the user presets a substitute content in the video/sound player 100.

First, the user operates the input unit 112 to instruct display of a menu screen to set a substitute content.

In response to the instruction, the control unit 110 provides the display unit 105 with display data for the menu screen, and displays the menu screen on the display unit 105.

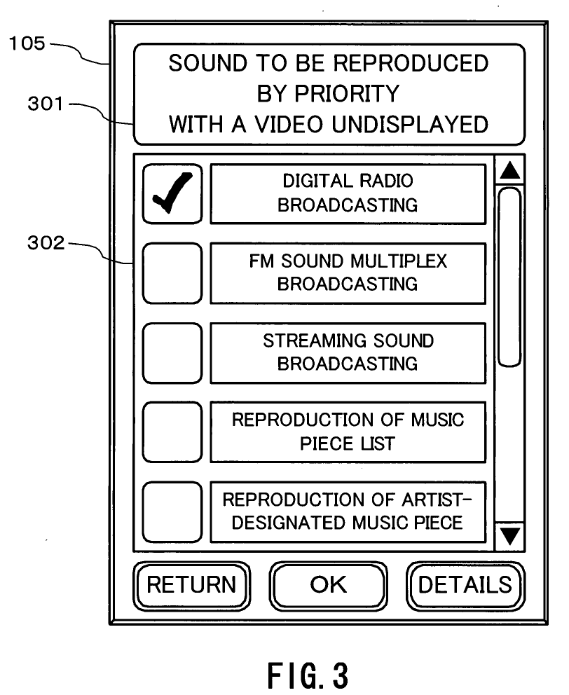

FIG. 3 is a diagram showing an example of the menu screen.

As shown in FIG. 3, the menu screen has a setting-item display area 301 and a functional-item display area 302. The setting-item display area 301 is where a setting item to be set in the video/sound player 100 by the user is displayed. The functional-item display area 302 is where a list of functional items settable for each setting item is displayed. A plurality of functional items corresponding to what is displayed in the setting-item display area 301 are displayed in the functional-item display area 302 in a selectable manner. The functional-item display area 302 has so-called check boxes displayed in association with the respective functional items. A check mark is displayed in a check box corresponding to a functional item selected by the user. Displaying a check mark indicates a set function to the user.

In the embodiment, the user sets a substitute content using this menu screen. First, the user operates the input unit 112 to select, for example, a setting item “sound to be reproduced by priority with a video undisplayed” from a plurality of setting items. Then, the control unit 110 displays the selected setting item in the setting-item display area 301 and displays, in the functional-item display area 302, functional items corresponding to the setting item displayed in the setting-item display area 301. Specifically, substitute contents which are candidates for “sound to be reproduced by priority with a video undisplayed” are displayed as functional items. For example, functional items representing information useful with a sound alone, such as “digital radio broadcasting”, “FM sound multiplex broadcasting”, “streaming sound broadcasting”, “reproduction of music piece list”, and “reproduction of artist-designated music piece”, are displayed in the functional-item display area 302. The “reproduction of music piece list” indicates reproduction of music pieces prestored in the data storage unit 102, in a predetermined order. The “reproduction of artist-designated music piece” indicates reproduction of music pieces of a pre-designated artist from among music pieces prestored in the data storage unit 102, in order.

The user operates the input unit 112 to select a desired functional item from a plurality of functional items indicating substitute contents, and puts a check mark in the check box corresponding to the selected functional item. This allows the user to set a substitute content.

When a process to edit the setting of a substitute content is needed thereafter, the video/sound player 100 performs an editing operation through an ordinary process according to the user operation.

When “digital radio broadcasting” or “FM sound multiplex broadcasting” is set as a substitute content, for example, its channel number or the like is set next according to the user operation. When “streaming sound broadcasting” is set as a substitute content, the URL (Uniform Resource Locator) or the like of a stream-distributed content is set according to the user operation. When “reproduction of music piece list” is set as a substitute content, the order of reproduction of music pieces or the like is set according to the user operation. When “reproduction of artist-designated music piece” is set as a substitute content, the designation of an artist or the like is set according to the user operation.

The control unit 110 stores information for specifying the set substitute content in the data storage unit 102.

A substitute content is set by the sequence of operations.

Thereafter, the user views a content including a video image and a sound using the video/sound player 100.

For example, the user instructs the video/sound player 100 to receive and reproduce desired digital television broadcasting including a video image and a sound via the input unit 112.

In response to the instruction, the control unit 110 gives instructions to the reception unit 101, the decoding unit 103, the video processing unit 104, the sound processing unit 106, etc. to execute a reception process and reproduction process.

In response to the instruction from the control unit 110, the reception unit 101 receives a broadcast wave of digital television broadcasting via the antenna. Then, the reception unit 101 demodulates the broadcast wave obtained through the antenna to restore digital content data which can be digitally processed in the decoding unit 103. The reception unit 101 supplies the restored digital content data to the decoding unit 103.

The decoding unit 103 separates video data and sound data included in the digital content data received by the reception unit 101 therefrom. Then, the decoding unit 103 decodes the separated video data and sound data to convert them to a predetermined video signal and a predetermined sound signal, respectively. The decoding unit 103 outputs the video signal and the sound signal to the video processing unit 104 and the sound processing unit 106, respectively. The control unit 110 synchronizes the output timings for the video signal and the sound signal so that the video signal and the sound signal are output in association with each other.

The video processing unit 104 converts the video signal supplied from the decoding unit 103 to a signal suitable for an input to the display unit 105, and outputs the converted video signal to the display unit 105. Accordingly, a video image of digital television broadcasting is displayed on the display unit 105.

The sound processing unit 106 converts the sound signal supplied from the decoding unit 103 to a signal suitable for an input to the speaker 107 or the sound output terminal 108, and outputs the converted sound signal to the speaker 107 or the sound output terminal 108. Accordingly, a sound of digital television broadcasting is output from the speaker 107 or the sound output device 109 connected to the sound output terminal 108 via the sound output terminal 108.

The output destination for the sound is set according to the user operation. Specifically, the control unit 110 receives setting information of the output destination for the sound via the input unit 112. Based on the setting information, the sound processing unit 106 sends the sound signal received from the decoding unit 103 to either one or both of the speaker 107 and the sound output terminal 108.

The control unit 110 may discriminate whether or not the sound output device 109 is connected to the sound output terminal 108, and change the output destination for a sound based on the discrimination result. When the sound output device 109 is not connected to the sound output terminal 108, for example, the control unit 110 causes the sound processing unit 106 to send a sound signal to the speaker 107. When the sound output device 109 is connected to the sound output terminal 108, on the other hand, the control unit 110 causes the sound processing unit 106 to send a sound signal to the sound output terminal 108, not the speaker 107.

Through the sequence of operations, the video/sound player 100 reproduces digital television broadcasting which is digital content data including a video image and a sound.

When the video/sound player 100 according to the embodiment is folded during reproduction of digital content data including a video image and a sound, the video/sound player 100 switches reproduction of the digital content data including a video image and a sound to reproduction of substitute content data including a sound but no video image.

A detailed description will now be given of the switching process of switching a content (digital content data) which the video/sound player 100 is reproducing.

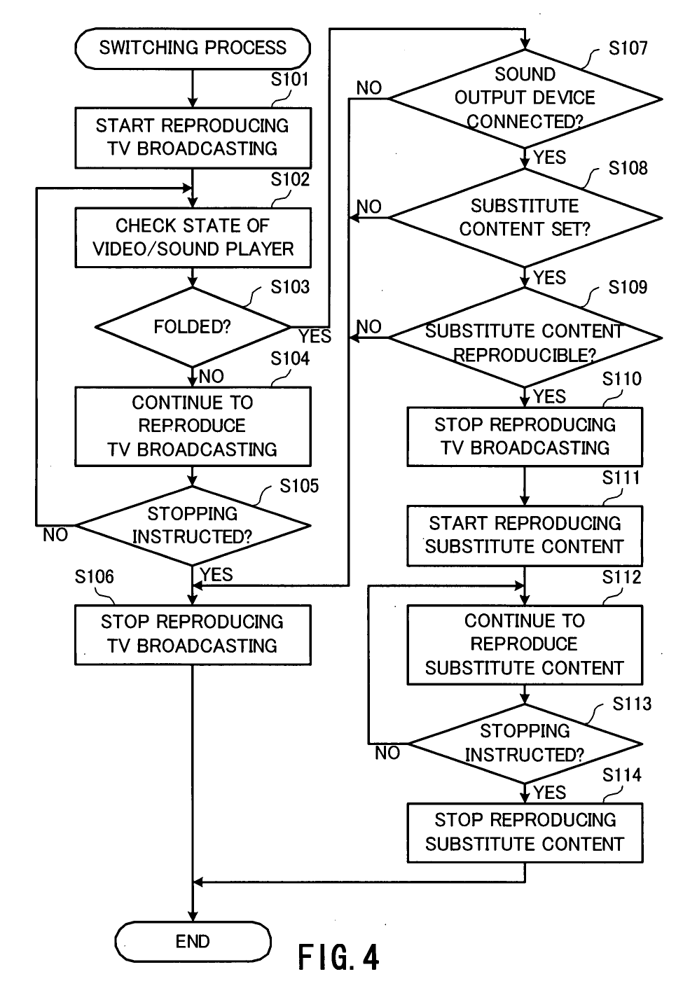

FIG. 4 is a flowchart illustrating an example of the switching process.

The switching process is initiated, for example, when the user instructs reproduction of a content including a video image and a sound by using the input unit 112, with the video/sound player 100 unfolded. The following description will be given of a case where reproduction of television broadcasting as a content including a video image and a sound is instructed.

First, the video/sound player 100 starts reproducing television broadcasting in response to the user's instruction to reproduce television broadcasting (step 101). Specifically, the control unit 110 displays, on the display unit 105, the video image of television broadcasting of a predetermined channel designated by the user, and outputs the sound from the speaker 107 or the sound output device 109. The user views the television broadcasting by listening to the sound output from the speaker 107 or the sound output device 109 while watching the video image to be displayed on the display unit 105.

Next, the control unit 110 checks if the video/sound player 100 is folded based on the signal output from the sensor unit 111 (step 102).

Subsequently, based on the check result, the control unit 110 discriminates whether the video/sound player 100 is folded or not (step 103). Specifically, the control unit 110 discriminates whether or not the video/sound player 100 has changed to the state B shown in FIG. 2B from the state A shown in FIG. 2A. That is, the control unit 110 discriminates whether or not the video/sound player 100 has changed its state to the state where user cannot watch a video image but can listen to a sound alone during reproduction of television broadcasting. Accordingly, it is discriminated whether or not the user is viewing the video image of television broadcasting.

When it is discriminated that the video/sound player 100 is not folded (step 103: No), the control unit 110 continues to reproduce the television broadcasting (step 104). Specifically, the control unit 110 continues the process of displaying the video image of the television broadcasting and the process of outputting the sound.

Then, the control unit 110 discriminates whether or not stopping of reproduction of the television broadcasting is instructed via the input unit 112 according to the user operation (step 105).

When stopping of reproduction of the television broadcasting is instructed (step 105: Yes), the control unit 110 stops reproducing the television broadcasting (step 106), and terminates the switching process.

When stopping of reproduction of the television broadcasting is not instructed (step 105: No), the control unit 110 returns to step 102 and repeats to check if the video/sound player 100 is folded and the subsequent discrimination.

When the control unit 110 discriminates in step 103 that the video/sound player 100 is folded (step 103: Yes), the control unit 110 goes to step 107.

That is, when the video/sound player 100 is folded and the display unit 105 is covered with the second casing 203, the control unit 110 executes the following three discrimination processes.

In the first discrimination process, the control unit 110 discriminates whether the sound output device 109 is connected to the sound output terminal 108 or not (step 107).

When the control unit 110 discriminates that the sound output device 109 is connected to the sound output terminal 108 (step 107: Yes), the control unit 110 goes to step 108 to execute the second discrimination process.

When the control unit 110 discriminates that the sound output device 109 is not connected to the sound output terminal 108 (step 107: No), the control unit 110 goes to step 106 to stop reproducing the television broadcasting (step 106), and then terminates the switching process. That is, the control unit 110 stops reproducing the television broadcasting without switching to the reproduction of a substitute content.

In the second discrimination process, the control unit 110 discriminates whether a substitute content is set or not (step 108). Specifically, the control unit 110 discriminates whether or not information for specifying the substitute content designated as “sound to be reproduced by priority with a video undisplayed” is stored in the data storage unit 102.

When the control unit 110 discriminates that the substitute content is set (step 108: Yes), the control unit 110 goes to step 109 to execute the third discrimination process.

When the control unit 110 discriminates that the substitute content is not set (step 108: No), the control unit 110 goes to step 106 to stop reproducing the television broadcasting (step 106), and then terminates the switching process. That is, the control unit 110 stops reproducing the television broadcasting without switching to the reproduction of the substitute content.

In the third discrimination process, the control unit 110 discriminates whether the substitute content is reproducible or not (step 109). When “FM sound multiplex broadcasting” or “digital radio broadcasting” is set as a substitute content, for example, the control unit 110 discriminates whether or not those broadcastings can be received. When “streaming sound broadcasting” is set as a substitute content, the control unit 110 discriminates whether or not radio communication is possible. When “reproduction of music piece list” or “reproduction of artist-designated music piece” is set as a substitute content, the control unit 110 discriminates whether or not there is a sound file to be reproduced.

When the control unit 110 discriminates that the substitute content is reproducible (step 109: Yes), the control unit 110 goes to step 110 to switch the reproduction target to the substitute content.

When the control unit 110 discriminates that the substitute content is not reproducible (step 109: No), the control unit 110 goes to step 106 to stop reproducing the television broadcasting (step 106), and then terminates the switching process. That is, the control unit 110 stops reproducing the television broadcasting without switching to the reproduction of the substitute content.

When the control unit 110 discriminates that the substitute content is reproducible (step 109: Yes), the control unit 110 first stops reproducing the television broadcasting the user has been viewing (step 110).

Next, the control unit 110 starts reproducing the substitute content preset by the user (step 111). When “digital radio broadcasting” is set as a substitute content, for example, the control unit 110 gives instructions to the reception unit 101, the decoding unit 103, the sound processing unit 106, etc. to execute the reception process and the reproduction process of digital radio broadcasting.

That is, when the video/sound player 100 reproduces substitute content data constituted by sound data, the decoding unit 103 does not output a video signal to the video processing unit 104 but outputs a sound signal only to the sound processing unit 106. The sound processing unit 106 sends this sound signal to the sound output device 109 via the sound output terminal 108. As a result, the sound of the substitute content is output from the sound output device 109, so that the user can listen to the sound of the substitute content.

Subsequently, the control unit 110 continues to reproduce the substitute content (step 112), and discriminates whether or not stopping of the reproduction of the substitute content is instructed (step 113). When stopping of the reproduction of the substitute content is not instructed (step 113: No), the control unit 110 returns to step 112 to continue the reproduction of the substitute content until stopping thereof is instructed.

When stopping of the reproduction of the substitute content is instructed (step 113: Yes), the control unit 110 stops reproducing the substitute content (step 114), and terminates the switching process. The digital content data useful with a sound alone is reproduced by the sequence of operations (steps 107-114).

Through the above-described switching process, when the user stops viewing a video image by folding the video/sound player 100 while viewing a content including a video image and a sound, the video/sound player 100 stops reproducing the content that has been reproduced so far, and starts reproducing a content useful with a sound alone, which is preset by the user. When the user stops viewing a video image, for example, the video/sound player 100 switches the reproduction of television broadcasting including a video image and a sound to the reproduction of radio broadcasting which includes a sound but does not include a video image.

According to the embodiment, therefore, when the user does not view a video image, it is possible to reproduce content useful with a sound alone which is set according to the user's preference. It is also possible to smoothly change a content to be reproduced according to the circumstance such as whether or not the user has folded the video/sound player 100.

According to the embodiment, through the process of the step 107, when the user is listening to the sound of a content from the sound output device 109, the reproduction of the content including a video image and a sound can be switched to the reproduction of a content useful with a sound alone.

According to the embodiment, through the process of the step 103, when the display unit 105 is detected as shielded in the process of the step 103 during reproduction of a content including a video image and a sound, the reproduction of the content including the video image and the sound can be switched to the reproduction of a content useful with a sound alone.

According to the embodiment, in the video/sound player 100 which can be folded in such a way as to shield the display unit 105, the reproduction of the content including a video image and a sound can be switched to the reproduction of a content useful with a sound alone.

According to the embodiment, the reproduction of digital television broadcasting can be switched to the reproduction of a content useful with a sound alone.

According to the embodiment, the user can preselect a substitute content to be switched from a plurality of substitute contents.

The description of the embodiment has been given of a case where television broadcasting to be externally received as a broadcast wave is mentioned as an example of a content including a video image and a sound which the user views using the video/sound player 100. However, a content including a video image and a sound is not limited to this type, but may be a content prestored in the data storage unit 102 in a predetermined method, a content stream-distributed by radio communication.

The description of the embodiment has been given of a case where a content which does not include a video image is mentioned as a substitute content. However, sound data of a content including a video image and a sound may be used as a substitute content. When the user stops viewing a video image, for example, only the music piece of a content which includes a combination of a music piece and a video image and is stored in the data storage unit 102 may be reproduced instead of television broadcasting.

In the switching process according to the embodiment, the reproduction of a substitute content continues until stopping of the reproduction thereof is instructed in step 113. However, it may be discriminated whether or not the closed state (folded state) of the video/sound player 100 is changed to the open state (unfolded state) thereof while the reproduction of a substitute content continues, and the reproduction target may be returned to television broadcasting when the video/sound player 100 is opened.

In the switching process according to the embodiment, it is discriminated in step 107 whether or not the sound output device 109 is connected to the sound output terminal 108, and when the sound output device 109 is not connected thereto, the video/sound player 100 does not switch the reproduction target to a substitute content. When the sound output device 109 is not connected to the sound output terminal 108, however, the video/sound player 100 may switch the reproduction target to a substitute content to output the sound of the substitute content from the speaker 107. In this case, the user can enjoy the sound of the substitute content through the speaker 107.

### Second Embodiment

Next, the second embodiment of the invention will be described. In the video/sound player 100 according to the second embodiment, the sensor unit 111 shown in FIG. 1 is constituted by a sensor which detects the illuminance of light.

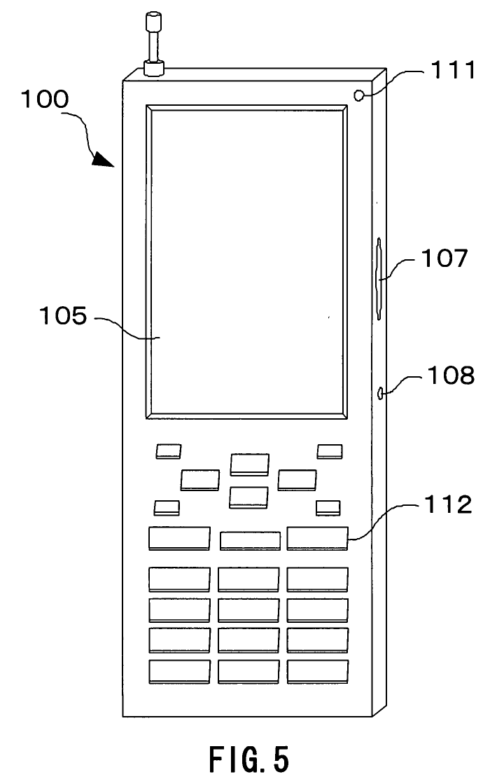

FIG. 5 is a diagram exemplarily showing the appearance of the video/sound player 100 according to the second embodiment. To avoid a redundant description, like or same reference numerals are given to those components of the second embodiment in FIG. 5 which are equivalent to the corresponding components of the first embodiment explained above.

As shown in FIG. 5, the video/sound player 100 according to the second embodiment, unlike the video/sound player 100 according to the first embodiment as shown in FIGS. 2A and 2B, does not have the hinge portion 201 and cannot therefore be folded.

The video/sound player 100 of the second embodiment comprises a single casing in which the display unit 105, the speaker 107, the sound output terminal 108, the sensor unit 111, the input unit 112, etc. are disposed.

The sensor unit 111 of the second embodiment detects the illuminance of light (ambient brightness), not folding of the video/sound player 100. The sensor unit 111 is disposed near the display unit 105. When the user stops viewing a video image using the video/sound player 100, the user places the video/sound player 100 in, for example, a pocket of clothes, a bag or the like. With the video/sound player 100 placed in a pocket or the like, the surrounding of the video/sound player 100 becomes dark, making the illuminance detected by the sensor unit 111 smaller. Based on the detection signal from the sensor unit 111, the control unit 110 discriminates whether or not the surrounding of the video/sound player 100 has become dark.

The operation of the video/sound player 100 with the above-described configuration will be explained next. In the second embodiment, it is discriminated that the user stops viewing a video image when the surrounding of the video/sound player 100 becomes dark. When the user places the video/sound player 100 in a pocket or so while viewing a content including a video image and a sound with the video/sound player 100 and stops viewing a video image, the video/sound player 100 switches the reproduction of the content which has been viewed to the reproduction a substitute content.

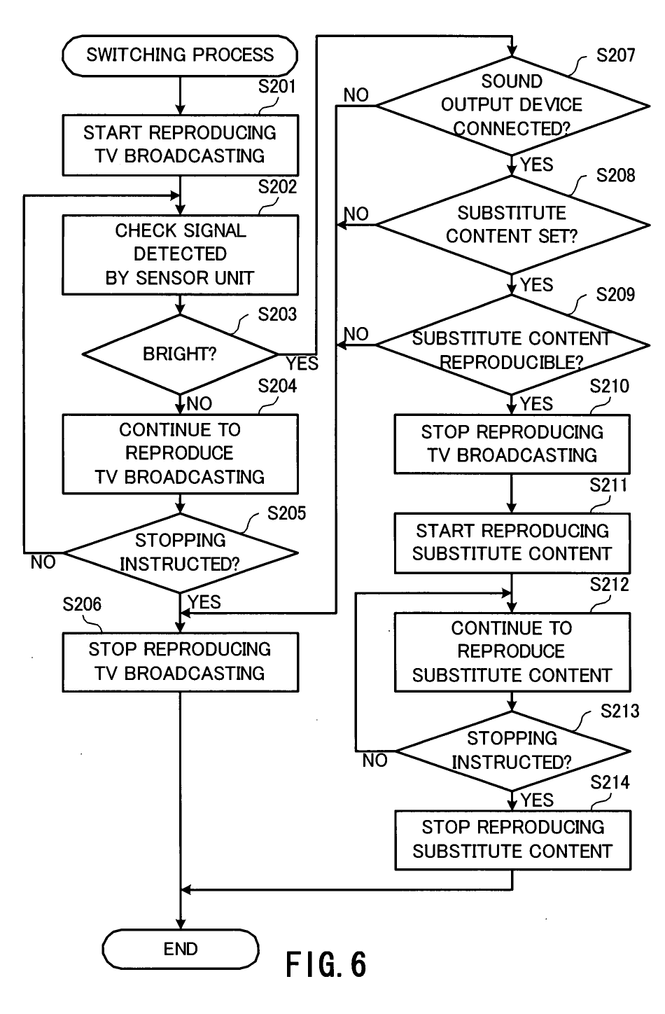

FIG. 6 is a flowchart illustrating an example of a switching process according to the second embodiment.

The switching process shown in FIG. 6 is the same as the switching process according to the first embodiment shown in FIG. 4, except for steps 202 and 203.

In step 102 of the switching process according to the first embodiment shown in FIG. 4, the control unit 110 checks if the video/sound player 100 is in a folded state based on the detection signal from the sensor unit 111. In the second embodiment, however, the control unit 110 checks a signal indicative of the illuminance of light detected by the sensor unit 111 (step 202).

In step 103 of the switching process according to the first embodiment shown in FIG. 4, the control unit 110 discriminates whether the video/sound player 100 is folded or not based on the check result. In the second embodiment, however, the control unit 110 discriminates whether or not the surrounding of the sensor unit 111 is brighter than a predetermined brightness based on the signal checked in step 202 (step 203). Specifically, the control unit 110 discriminates whether or not the illuminance detected by the sensor unit 111 is greater than a predetermined illuminance (threshold) set beforehand. When the detected illuminance is greater than the threshold, the control unit 110 discriminates that the surrounding of the sensor unit 111 is bright.

When the control unit 110 discriminates that the surrounding of the sensor unit 111 is bright (step 203: Yes), the control unit 110 continues to reproduce the television broadcasting as per the first embodiment (step 204). The subsequent processes (steps 205 and 206) in the second embodiment are the same as those of the first embodiment.

When the control unit 110 discriminates that the surrounding of the sensor unit 111 is dark (step 203: No), on the other hand, the control unit 110 considers that the video/sound player 100 is placed in a pocket or so of the user's clothes and the user stops viewing a video image. When the surrounding of the sensor unit 111 is discriminated as being dark, therefore, processes similar to those which are executed when it is discriminated that the video/sound player 100 is folded in the first embodiment are executed (steps 207 to 214).

Even when the video/sound player 100 does not have a foldable configuration, the use of a sensor which detects the illuminance of light in the sensor unit 111 can permit switching of a content to be reproduced when the user stops viewing a video image.

According to the second embodiment, therefore, the user does not view a video image, it is possible to reproduce a content useful with a sound alone which is set according to the user's preference. It is also possible to smoothly change a content to be reproduced according to the circumstance such as whether or not the user has placed the video/sound player 100 in a pocket or so.

### Third Embodiment

The third embodiment of the invention will be described next. When the user stops viewing a video image of a content (broadcast content) received as a broadcast wave, the video/sound player 100 according to the third embodiment switched the reproduction target to a substitute content and, at the same time, starts recording the broadcast wave that has been viewed so far. When the user comes to a state of starting viewing a video image again, the video/sound player 100 reproduces the recorded data.

The operation of the video/sound player 100 according to the third embodiment will be described below. The configuration of the video/sound player 100 according to the third embodiment is the same as the configuration of the video/sound player 100 according to the first embodiment shown in FIG. 1. To avoid a redundant description, like or same reference numerals are given to those components of the third embodiment which are equivalent to the corresponding components of the first embodiment explained above.

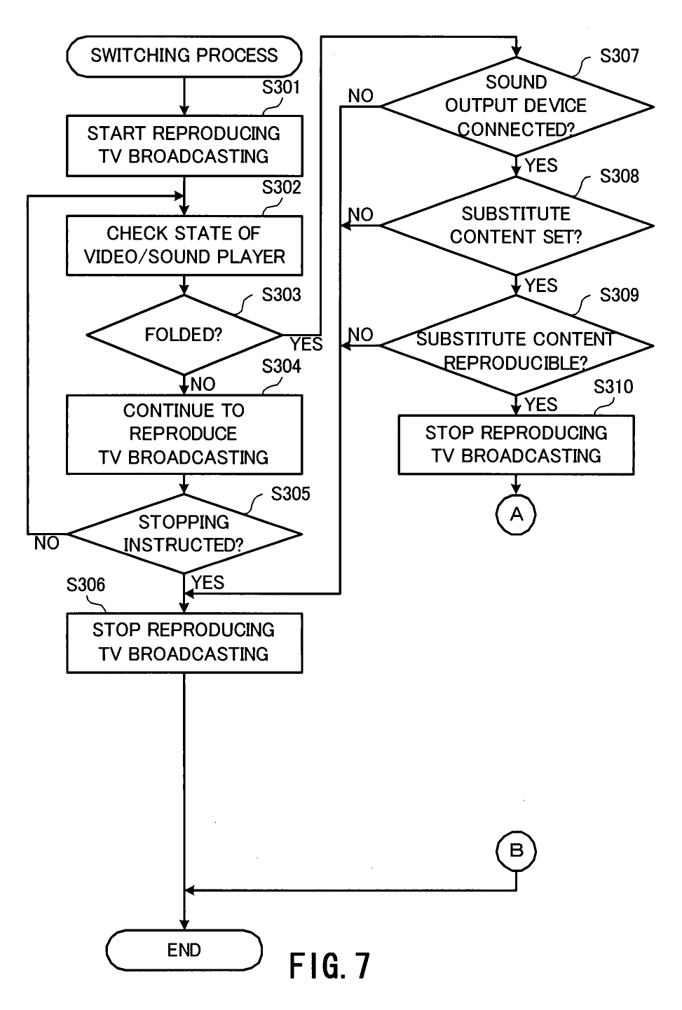

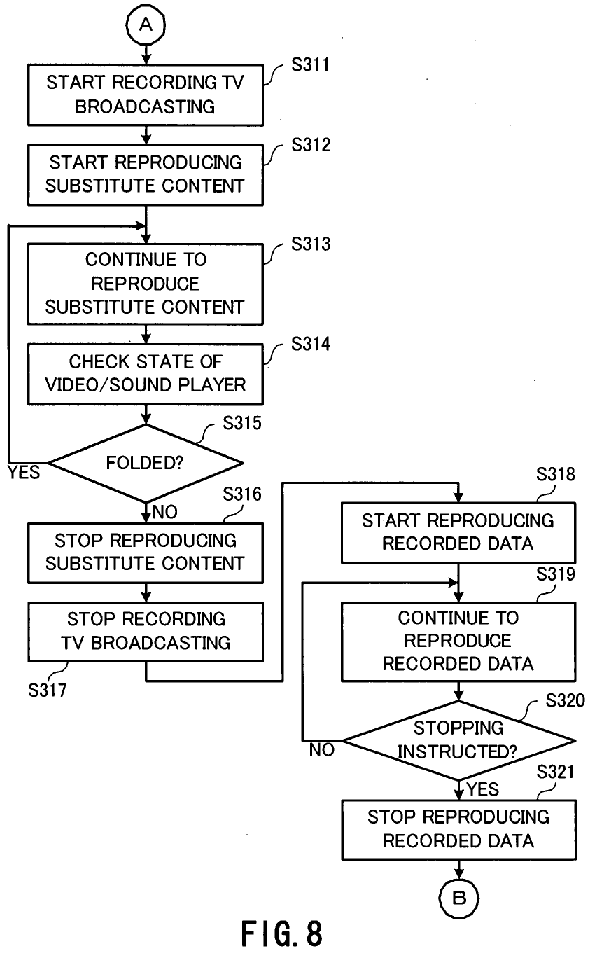

FIGS. 7 and 8 are flowcharts illustrating an example of a switching process according to the third embodiment.

The switching process shown in FIGS. 7 and 8 is the same as the switching process according to the first embodiment shown in FIG. 4, except for steps 311 to 321.

The processes of steps 311 to 321 which distinguish the third embodiment from the first embodiment will be described below.

First, through the same processes (steps 301 to 310 in FIG. 7) as the processes of steps 101 to 110 in FIG. 4 of the first embodiment, when the video/sound player 100 is folded (step 303: Yes), the control unit 10 executes three discrimination processes (steps 307 to 309) and stops reproducing television broadcasting (step 310).

Thereafter, the control unit 110 controls the decoding unit 103 to start recording the television broadcasting whose reproduction has been stopped (step 311 in FIG. 8). At this time, the decoding unit 103 records digital content data including a video image and a sound received from the reception unit 101 into the data storage unit 102.

Next, through the same processes as the processes of steps 111 and 112 in FIG. 4 of the first embodiment, the control unit 110 starts reproducing a substitute content preset by the user (step 312), and continues the reproduction thereof (step 313).

Further, based on the signal output from the sensor unit 111, the control unit 110 checks if the video/sound player 100 is in a folded state during reproduction of the substitute content (step 314).

Based on the check result, the control unit 110 discriminates whether or not the video/sound player 100 is folded (step 315).

When the video/sound player 100 is folded (step 315: Yes), the control unit 110 returns to step 313 to continue the reproduction of the substitute content.

When the video/sound player 100 is not folded (step 315: No), on the other hand, the control unit 110 stops reproducing the substitute content (step 316). Specifically, when the video/sound player 100 is opened by the user and is returned to the state A where the user can view a video image from the closed state B, the control unit 110 gives instructions to the individual sections of the video/sound player 100 which are associated with the reproduction of a sound to stop reproducing the sound.

The control unit 110 then controls the decoding unit 103 to stop recording television broadcasting (step 317).

Further, the control unit 110 controls the decoding unit 103 to starts reproducing recorded data of the television broadcasting recorded in the data storage unit 102 (step 318).

Subsequently, the control unit 110 continues to reproduce the recorded data (step S319), and discriminates whether or not stopping of reproduction of the recorded data is instructed (step 320). When no instruction to stop the reproduction is given (step 320: No), the control unit 110 returns to step 319 to continue the reproduction the recorded data. That is, the control unit 110 monitors the user's operation to stop reproduction of recorded data via the input unit 112, and keeps reproducing digital content data (recorded data) until an operation of stopping the reproduction thereof is detected.

When stopping of the reproduction of the recorded data is instructed (step 320: Yes), the control unit 110 stops reproducing the recorded data (step 321), and terminates the switching process.

As apparent from the above, when the user stops viewing a content including a video image and a sound during the reproduction thereof, the video/sound player 100 according to the third embodiment switches the reproduction target to a substitute content which includes a sound but does not include a video image. At the same time, the video/sound player 100 starts recording the content including a video image and a sound which has been viewed by the user. When the state of the video/sound player 100 returns to the state where the user can view a content including a video image and a sound, the recorded content including the video image and the sound is reproduced.

According to the third embodiment, therefore, a content to be reproduced can be smoothly changed according to how the video/sound player 100 is used by the user.

According to the third embodiment, the content which the user has stopped viewing can be stored, at the point of time when the viewing has been stopped.

According to the third embodiment, when the user resumes to view the content which the user has stopped viewing, the user can view that portion of the content which has not been viewed.

Although the first to third embodiments of the invention which have been described above, the invention is not limited to those three embodiments, and various modifications and applications are possible in working out the invention.

For example, while digital content data is reproduced in the embodiments, analog content data may be reproduced instead.

Further, the reproduction of a content including a video image and a sound is switched to the reproduction of a substitute content in the embodiments. However, the reproduction of a content including a video image alone, not a sound, may be switched to the reproduction of a substitute content.

The video/sound player 100 may be a portable information terminal, such as a cellular phone or a PDA (Personal Digital Assistant).

The functions of the video/sound player 100 according to each embodiment discussed above can be realized by exclusive hardware as well as an ordinary computer system.

In the above-described embodiments, the operational programs are prestored in the ROM or the like in the video/sound player 100. However, the programs for executing the processes may be stored in a computer readable recording medium, such as a CD-ROM (Compact Disk Read-Only Memory), DVD (Digital Versatile Disk) or MO (Magneto-Optical disk), for distribution, and may be installed in a computer to configure an apparatus which execute the above-described operations.

The programs may be stored in a disk drive unit or the like of a predetermined server apparatus on a communication network, such as the Internet, and may be downloaded into a computer in the form of a carrier wave on which the programs are superimposed. Further, the above-described processes can be achieved as the programs transferred over the communication network are activated and executed.

When the above-described functions are shared and realized by the OS (Operating System) or the cooperation of the OS and an application, for example, those portions which are not achieved by the OS may be stored in a medium for distribution, or downloaded into a computer.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2006-134442 filed on May 12, 2006 and including specification, claims, drawings and summary. The disclosure of the above Japanese Patent Application is incorporated herein by reference in its entirety.

What is claimed is:

1. A video/sound player comprising:
a content reproduction unit that reproduces a content including at least one of a video image and a sound and outputs at least one of a video signal and a sound signal;
a discrimination unit that discriminates whether or not a user is viewing a video image of a content including a video image reproduced by the content reproduction unit; and
a content reproduction control unit that, while the content reproduction unit is reproducing a content including a video image, causes the content reproduction unit to reproduce predetermined sound data in place of the content which is being reproduced by the content reproduction unit, when the discrimination unit discriminates that the user is not viewing the video image of the content.

2. The video/sound player according to claim 1, further comprising:
an external output terminal to which a sound output device is connected; and
a sound signal supply unit that supplies a sound signal from the content reproduction unit to the sound output device connected to the external output terminal,
wherein when the discrimination unit discriminates that the user is not viewing a video image and the sound output device is connected to the external output terminal, the content reproduction control unit causes the content reproduction unit to reproduce the predetermined sound data.

3. The video/sound player according to claim 1, further comprising:
an external output terminal to which a sound output device is connected;
a speaker; and
a sound signal supply unit that supplies a sound signal from the content reproduction unit to the sound output device via the external output terminal when the sound output device is connected to the external output terminal, and supplies the sound signal to the speaker when the sound output device is not connected to the external output terminal.

4. The video/sound player according to claim 1, further comprising a display device having a display screen,
wherein the video/sound player is configured so as to be able to switch a state of the display screen of the display device between a state where the display screen is shielded and a state where the display screen is exposed, and
the discrimination unit discriminates that the user is not viewing a video image when the display screen of the display device is shielded.

5. The video/sound player according to claim 4, further comprising:
a casing; and
a mechanism that switches the state of the display screen of the display device between the state where the display screen is exposed and a state where the display screen is shielded by the casing, by changing the facing direction of the display screen of the display device with respect to the casing,
wherein the discrimination unit discriminates that the user is not viewing a video image when the display screen of the display device is shielded by the casing.

6. The video/sound player according to claim 1, further comprising a sensor that detects an ambient brightness,
wherein the discrimination unit discriminates that the user is not viewing a video image when the ambient brightness detected by the sensor is lower than a predetermined brightness.

7. The video/sound player according to claim 1, wherein the content reproduction unit has a reception unit that receives digital television broadcasting, and a digital broadcasting reproduction unit that reproduces the digital television broadcasting received by the reception unit and outputs a video signal and a sound signal thereof, and
the discrimination unit discriminates whether or not the user is viewing a video image of the digital television broadcasting reproduced by the digital broadcasting reproduction unit during reception of the digital television broadcasting by the reception unit.

8. The video/sound player according to claim 7, wherein the reception unit receives digital television broadcasting and at least one digital broadcasting of digital radio broadcasting, FM sound multiplex broadcasting and streaming sound broadcasting,
the digital broadcasting reproduction unit reproduces the digital broadcasting received by the reception unit and outputs a signal thereof,
the predetermined sound data is sound data of one digital broadcasting designated beforehand from digital radio broadcasting, FM sound multiplex broadcasting and streaming sound broadcasting by the user, and
the content reproduction control unit causes the content reproduction unit to reproduce the predetermined sound data in place of the digital television broadcasting when the discrimination unit discriminates that the user is not viewing a video image of the digital television broadcasting.

9. The video/sound player according to claim 1, further comprising a content storage unit,
wherein the content including a video image is a broadcasting content, and
the content reproduction control unit starts reproducing the predetermined sound data and starts recording a broadcasting content which has been reproduced so far into the content storage unit, when the discrimination unit discriminates that the user is not viewing a video image.

10. The video/sound player according to claim 9, wherein when the video/sound player returns to a state where the user can view a video image after reproduction of the predetermined sound data is started, the content reproduction control unit causes the content reproduction unit to reproduce the broadcasting content recorded in the content storage unit in place of the predetermined sound data which is being reproduced.

11. A video/sound reproducing method comprising:
a reproduction step of reproducing a first content including a video image;
a display step of displaying the video image of the first content reproduced in the reproduction step on a display unit;
a discrimination step of discriminating whether or not a state of the display unit is a visible state where a user can view the video image displayed in the display step; and
a reproduction switching step of switching the reproduction of the first content to reproduction of a second content including sound and different from the first content, when it is discriminated in the discrimination step that the display unit is not in the visible state.

12. The video/sound reproducing method according to claim 11, wherein the discrimination step discriminates whether or not the display unit is covered, and discriminates that the display unit is not in the visible state when the display unit is covered.

13. The video/sound reproducing method according to claim 11, wherein the discrimination step discriminates whether or not an illuminance near the display unit is lower than a predetermined illuminance, and discriminates that the display unit is not in the visible state when the illuminance near the display unit is lower than the predetermined illuminance.

14. A computer readable recording medium recording a program for allowing a computer to execute:
a reproduction step of reproducing a first content including a video image;
a display step of displaying the video image of the first content reproduced in the reproduction step on a display unit;
a discrimination step of discriminating whether or not a state of the display unit is a visible state where a user can view the video image displayed in the display step; and
a reproduction switching step of switching the reproduction of the first content to reproduction of a second content including sound and different from the first content, when it is discriminated in the discrimination step that the display unit is not in the visible state.

15. A computer data signal embodied in a carrier wave representing a program for allowing a computer to execute:
a reproduction step of reproducing a first content including a video image;
a display step of displaying the video image of the first content reproduced in the reproduction step on a display unit;
a discrimination step of discriminating whether or not a state of the display unit is a visible state where a user can view the video image displayed in the display step; and
a reproduction switching step of switching the reproduction of the first content to reproduction of a second content including sound and different from the first content, when it is discriminated in the discrimination step that the display unit is not in the visible state.
